(19) United States
(12) Patent Application Publication
(10) Pub. No.: US 2025/0231212 A1
(43) Pub. Date: Jul. 17, 2025

(54) MODULATION DETECTION IN THERMAL-BEAM ATOMIC SENSORS

(71) Applicant: AOSense, Inc., Fremont, CA (US)

(72) Inventors: Jeongwon Lee, San Jose, CA (US); Lucas Peng, San Jose, CA (US); Igor Teper, Half Moon Bay, CA (US); Miao Zhu, San Jose, CA (US); Mark A. Kasevich, Palo Alto, CA (US); Arman Cingoz, Santa Clara, CA (US); Matthew Todd Cashen, Gilroy, CA (US)

(21) Appl. No.: 19/015,273

(22) Filed: Jan. 9, 2025

Related U.S. Application Data
(60) Provisional application No. 63/620,088, filed on Jan. 11, 2024.

(51) Int. Cl. G01P 15/093

(52) U.S. Cl. CPC G01P 15/093

(57) ABSTRACT

A device includes one or more thermal atomic sources to provide one or more atomic beams. The device also includes a set of atom interference lasers disposed to provide interrogation laser beams that interrogate the one or more atomic beams to assist in generating atom interference. A phase, a frequency, or a phase and a frequency of one interrogation laser beams of the interrogation laser beams is toggled, shifted, or toggled and shifted to generate a modulation of an atomic interference signal.

### CROSS REFERENCE TO OTHER APPLICATIONS

This application claims priority to U.S. Provisional Patent Application No. 63/620,088 entitled SQUARE-WAVE MODULATION IN THERMAL-BEAM ATOMIC SENSORS filed Jan. 11, 2024 which is incorporated herein by reference for all purposes.

### GOVERNMENT LICENSE RIGHTS

This invention was made with government support. The government has certain rights in the invention.

### BACKGROUND OF THE INVENTION

Atom interferometers exploit the wave-like properties of atoms to sensitively measure small differences between different atomic spatial trajectories. Generally, this is done by measuring interference effects that result when a beam of atoms is manipulated such that the atomic wave packets are split into two or more components and subsequently recombined. The wave-like properties of matter allow interference measurements to be exploited at a scale orders of magnitude smaller than for light because the typical de Broglie wavelengths associated with massive particles are very small compared to wavelengths associated with massless photons of visible light. Examples of these precision measurements include high precision inertial sensing, gravity gradiometry, and measurements of fundamental physical constants and quantum phenomena. Some atom interferometer measurement techniques determine the probability that the atoms in the beam of atoms make a transition between two states.

### BRIEF DESCRIPTION OF THE DRAWINGS

Various embodiments of the invention are disclosed in the following detailed description and the accompanying drawings.

FIG. 1 is a block diagram illustrating an embodiment of the architecture of a thermal beam inertial sensor that can be used to implement modulation detection.

FIG. 2 is a graph demonstrating how fluctuations in interferometer contrast and/or atom number produce errors in interferometer phase readout for single-point measurements that do not account for these fluctuations.

FIG. 3 is a graph demonstrating the toggling of an interferometer phase and its effects on the readout in accordance with some embodiments.

FIG. 4 is a flow diagram illustrating an embodiment of modulation detection.

FIG. 5 is a flow diagram illustrating an embodiment of modulation detection using open-loop sinusoidal wave modulation.

FIG. 6 is a flow diagram illustrating an embodiment of modulation detection using closed-loop sinusoidal wave modulation.

FIG. 7 is a flow diagram illustrating an embodiment of modulation detection using closed-loop chirped sinusoidal-wave modulation.

FIG. 8 is a flow diagram illustrating an embodiment of modulation detection using open-loop square-wave modulation.

FIG. 9 is a flow diagram illustrating an embodiment of modulation detection using simultaneous closed-loop square-wave modulation.

FIG. 10 is a flow diagram illustrating an embodiment of modulation detection using interleaved closed-loop square-wave modulation.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for modulation detection in thermal-beam atomic sensors is disclosed. The system comprises one or more thermal atomic sources to provide one or more atomic beams and a set of atom interference lasers disposed to provide interrogation laser beams that interrogate the one or more atomic beams to assist in generating atom interference, wherein a phase, a frequency, or the phase and the frequency of one interrogation laser beams of the interrogation laser beams is toggled, shifted, or toggled and shifted to generate a modulation of an atomic interference signal.

An atom interferometer device for inertial sensing is disclosed. The atom interferometer device for inertial sensing comprises one or more thermal atomic sources, one or more state preparation laser, one or more atom interference lasers, and one or more detection lasers. The one or more thermal atomic sources provide one or more atomic beams. The one or more atom interference lasers are disposed to provide interrogation laser beams that interrogate the one or more atomic beams to assist in generating atom interference. A modulation is applied to one or more of the atom interrogation laser beams.

An atom interferometer produces an interferometer phase readout signal. The interferometer phase readout signal comprises the phase of atoms that have been interrogated by one or more beams, such as Raman beams. The phase of the atoms may be determined by measuring the probability that the atoms make a transition between two states.

However, measuring the probability that the atoms make a transition between two states may introduce overall complications. One overall complication is that the readout signals may comprise contributions from background atoms. Background atoms are atoms that are in one or both of the two atomic states but do not participate in the interferometer. In other words, the interferometer contrast is finite and possibly changing. It is undesirable for the phase readout signal to be affected by background atoms, as these atoms do not represent atoms that have been interrogated.

To address contributions from background atoms, interferometer contrast can be calibrated before the measurement. Then, the measurer may approximate the true measurement by treating the contrast as constant. This solution causes the measured interferometer phase to be affected by drifts. This is because over the course of the measurement the contrast changes. Another potential solution is to occasionally recalibrate the interferometer contrast. However, performing this recalibration during the course of a measurement further complicates the measurement sequence.

Another complication is that the total number of atoms may change. Thus, even if the interferometer contrast is fixed, the size of the detected atomic signals corresponding to a given interferometer phase will change. This is undesirable because the number of atoms will affect the probability that is represented by the readout signal. The changing total atom number may be addressed by measuring the final population in both atomic states. However, this is generally more complicated than only measuring the atoms in one state.

Techniques that mitigate the negative effects of changing contrast and/or atom number in the measurement of readout signals are disclosed herein. A modulation is applied to one or more of the interrogatory beams of an atom interferometry device. The modulation may be applied by toggling a phase, shifting the phase, toggling a frequency, shifting the frequency, toggling the phase and toggling the frequency, shifting the phase and toggling the frequency, toggling the phase and shifting the frequency, or shifting the phase and shifting the frequency. The relative phase between the atomic output oscillation and the reference electronic signal is measured. Upon demodulation using the reference electronic signal, the interferometer phase can be extracted such that the effects from interferometer contrast and/or atom number are mitigated. In some embodiments, the applied modulation is a sinusoidal wave. In some embodiments, the applied modulation is a square-wave.

For example, a sinusoidal wave modulation may be implemented in a

$$a \frac{π}{2} - π - \frac{π}{2}$$

thermal-beam interferometer by shifting the frequency of the π beam by a sinusoidal wave of f_{mod} relative to the frequencies of the π/2 beams. This generates a continuous scan in the interferometer output phase, which leads to an oscillation in the output signal at 2f_{mod}, where the phase of that oscillation, referenced to the phase of the modulation, corresponds to the interferometer phase. Lock-in detection enables extracting the interferometer phase in a way that is independent of interferometer contrast and atom number (as long as the fluctuations in interferometer contrast and atom number are slow compared to f_{mod}).

Another example uses a square-wave modulation, rather than continuously modulating the phase of the π pulse laser, the laser's phase is toggled by π/2 rad, which toggles the phase of the atom signal by π rad.

When using the sinusoidal modulation, lock-in detection is used to overcome the complications in thermal-beam inertial sensors while only measuring one of the atomic states. For example, in the case of a constant-frequency sinusoidal phase modulation being imposed on the atomic output signal, the lock-in detection can measure the relative phase between this atomic output oscillation and a reference electronic signal (derived from the signal used to produce the modulation). In a π/2-π-π/2 thermal-beam interferometer, shifting the frequency of the π beam relative to the frequencies of the π/2 beams by a frequency f_{mod} generates a continuous scan in the interferometer output phase, which leads to an oscillation in the output signal at 2f_{mod}, with the phase of that oscillation, referenced to the phase of the modulation, corresponding to the interferometer phase. Lock-in detection enables extracting the interferometer phase in a way that is independent of interferometer contrast and atom number (as long as the fluctuations in interferometer contrast and atom number are slow compared to f_{mod}).

If the phase measurement described above is performed simultaneously on two counterpropagating atomic beams, the interferometer phase for an applied acceleration will have the same sign for the two counterpropagating interferometers, while for an applied rotation it will have opposite signs for the two counterpropagating interferometers. Thus, the sum of the interferometer phases for the two counterpropagating interferometers will be proportional to the acceleration rate (in the direction along the Raman laser beams), while the difference of the interferometer phases for the two counterpropagating interferometers will be proportional to the rotation rate (around an axis perpendicular to the plane of the atom beams and Raman laser beams).

Because lock-in demodulation can only detect the interferometer phase modulo 2π, it is desirable, particularly under high platform dynamics, to operate the device such that the interferometer phases are near zero and the response to inputs is linear. This can be implemented via closed-loop operation, where phases applied to the interferometer laser beams compensate for the inertial phases produced by the platform acceleration and rotation to zero the measured interferometer phase, with the platform acceleration and rotation then extracted from the compensation phases.

In a π/2-π-π/2 thermal-beam interferometer, closed-loop operation via applying a biasing frequency shift with opposite sign to the two π/2 beams, where the biasing frequency is proportional to the platform rotation, can zero out the rotation phase. The platform rotation can then be derived from the biasing frequency shift. Furthermore, as a given atom traverses the interferometer region, both the interferometer phase it accumulates due to applied rotation and the compensation phase applied to it by the rotation-biasing frequency shift will scale linearly with the time it spends in the interferometer, meaning that a single rotation-biasing frequency shift will compensate the rotation phases for atoms of all velocities.

A similar technique can zero out the acceleration phase by applying a different biasing frequency shift either with the same sign to the two π/2 beams or just to the π beam, where this second biasing frequency shift is proportional to platform acceleration. The platform acceleration can then be derived from the second biasing frequency shift. Similar acceleration biasing can also be applied in open-loop to counteract interferometer contrast loss under applied gravity.

In this case, however, as a given atom traverses the interferometer region, the interferometer phase it accumulates due to applied acceleration scales quadratically with the time it spends in the interferometer, while the compensation phase applied to it by the acceleration-biasing frequency shift will scale linearly with the time it spends in the interferometer, meaning that a single acceleration-biasing frequency shift will fully compensate the acceleration phases for atoms of only one chosen velocity, and will only approximately compensate the acceleration phases for atoms of other velocities. The acceleration can be fully canceled in closed loop for all atom velocities via “chirped” acceleration compensation, where the applied acceleration is compensated via a linear frequency chirp applied simultaneously to the three Raman beams.

While this lock-in demodulation method has many advantages, it is vulnerable to fluctuations in the phase of the reference signal, which lead to fluctuations in the readout phase. Furthermore, the bandwidth of the lock-in demodulation readout is limited by the need to use a low-pass filter to filter out higher harmonics of 2f_{mod}.

A method to overcome these limitations, eliminating the sensitivity to radio frequency (RF) phase fluctuations and enabling higher sensor readout bandwidth as well an increase in the sensor readout signal to noise ratio (SNR), is to use square-wave, rather than sinusoidal, modulation and demodulation.

In square-wave modulation, rather than continuously modulating the phase of the π pulse laser, the laser's phase is toggled by π/2 rad, which toggles the phase of the atom signal by π rad. When the interferometer phase, which is the average of the two toggle phases, changes, this causes the amplitude of the modulated atomic signal to change; the amplitude goes to 0 when the interferometer phase is exactly π rad. Since the interferometer phase is read out directly via square-wave amplitude, the effect of RF phase fluctuations is suppressed. Near π rad interferometer phase, where the amplitude of the readout square wave is near 0, the interferometer has maximal sensitivity (largest change in readout signal for a given small change in interferometer phase), and the amplitude of the square-wave readout signal is linearly proportional to the interferometer phase. In sinusoidal modulation, the interferometer phase is necessarily scanned over 2π rad, so some time is spent in the least-sensitive phase regions; thus, for optimized square-wave modulation, the SNR is \sqrt{2} times the SNR for sinusoidal modulation.

An additional benefit of square-wave modulation is that, due to not requiring the RF filtering needed to suppress higher harmonics of the modulation frequency (as in sinusoidal modulation with lock-in detection), this modulation method can achieve much higher sensor readout bandwidth.

Similarly to sinusoidal modulation, if the square-wave modulation phase measurement is performed simultaneously on two counterpropagating atomic beams, the square-wave readout signal for an applied acceleration will be in-phase for the two counterpropagating interferometers, while for an applied rotation it will be out-of-phase for the two counterpropagating interferometers. Thus, the average of the interferometer phases for the two counterpropagating interferometers will be proportional to the acceleration rate (in the direction along the Raman laser beams), while the difference of the interferometer phases for the two counterpropagating interferometers will be proportional to the rotation rate (around an axis perpendicular to the plane of the atom beams and Raman laser beams).

Because the detected signal from the interferometer varies sinusoidally with the interferometer's phase, it is desirable, particularly under high platform dynamics, to operate the device such that the phase is near zero and the response to inputs is linear. This can be implemented via closed-loop operation, where phases applied to the interferometer laser beams compensate for the inertial phases produced by the platform acceleration and rotation to zero the measured interferometer phase, with the platform acceleration and rotation then extracted from the compensation phases. For such closed-loop operation, a high-bandwidth phase servo is required in order to capture the full bandwidth of platform dynamics, and the higher sensor readout bandwidth enabled by square-wave modulation enables higher closed-loop phase servo bandwidth.

In some embodiments, in closed-loop square-wave operation, the sensor can be operated in interleaved closed-loop mode, where the phases for the two counterpropagating atom beams are zeroed during alternating square-wave cycles, which can enable optimal zeroing of both acceleration and rotation. The servo compensation phases from adjacent cycles corresponding to zeroing of the phases for the two counterpropagating beams can then be added or subtracted to extract the rotation and acceleration signals, respectively. In this case, the phase servos work best for rotations and accelerations that are changing slowly compared to the square-wave modulation frequency, and thus the high modulation frequency enabled by square wave modulation enables high sensor measurement bandwidth.

Alternatively, the sensor can be operated in simultaneous closed-loop mode, where rather than zeroing the phase of each interferometer at different times, they are served simultaneously by applying two types of feedback, one of which zeroes the rotation phase (the difference of the two interferometer phases) and one which zeroes the acceleration phase (the sum of the two interferometer phases).

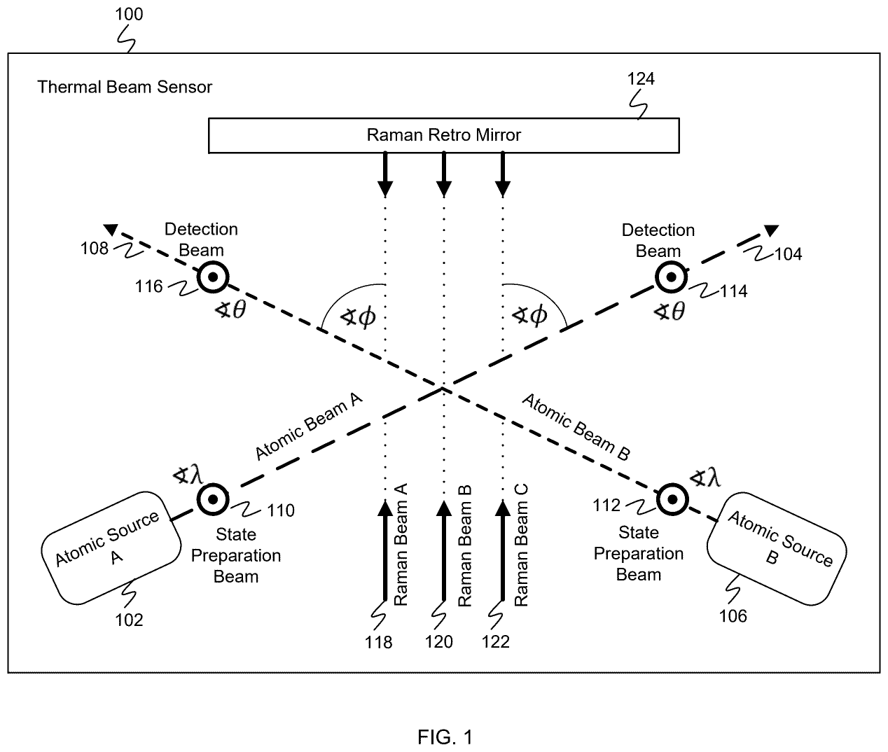

FIG. 1 is a block diagram illustrating an embodiment of a system architecture of a thermal beam inertial sensor that can be used to implement modulation detection. In the example shown, atomic source 102 generates atomic beam 104. Atomic source 106 generates atomic beam 108.

State preparation beam 110 and state preparation beam 112 put atoms from atomic beam 104 and atomic beam 108 into a desired internal quantum state by creating state-prepared atomic beams. For example, in the case of cesium, state preparation beam 110 and state preparation beam 112 simultaneously clear the F=4 ground state and optically pump the F=3 ground state atoms into the m_{F}=0 magnetic sublevel.

The state-prepared atomic beams then enter the atom interferometer (i.e., one state prepared atomic beam (atomic beam 104) enters from the left and one (atomic beam 108) enters from the right), which is created using a sequence of three interferometer interrogation beams (i.e., Raman beam A 118, Raman beam B 120, and Raman beam C 122). that are at an angle [symbol] ϕ with respect to atomic beam 104 and atomic beam 108.

Raman beam A 118, Raman beam B 120, and Raman beam C 122 comprise the interferometer interrogation beams. For example, interferometer interrogation beams are two-photon stimulated Raman transitions that are tuned to coherently split into a superposition of states and then recombine the atomic wave packets. At the output of the interferometer one can monitor the atomic population in the states that partake in the interferometer—in the case of cesium, in either the F=3 or F=4 atomic states, by using detection beam 114 and detection beam 116 which can be tuned, in the case of cesium, to the F=4 resonance to induce fluorescence proportional to the number of atoms in the F=4 state. The number of atoms in a particular atomic state after atoms exit the interferometer depends on the rotation or acceleration of the optical platform relative to the inertial trajectory of atoms in vacuum. In some embodiments, the number of atoms in a particular state can be measured by a photodetector that detects fluorescence scattered by atoms resonant with one or more detection laser beams. Detection beam 114 and detection beam 116 are used to detect fluorescence scattered by atoms resonant with one or more detection laser beams.

In this example, thermal beam sensor 100 comprises retro mirror 124 in which atomic beam 104 and atomic beam 108 are slightly tilted by an angle [symbol] ϕ with respect to Raman beam A 118, Raman beam B 120, and Raman beam C 122, are at an angle [symbol] λ with respect to state preparation beam 110 and state preparation beam 112, and are at an angle [symbol] θ with respect to detection beam 114 and detection beam 116. These angles result in a Doppler shift that can be used to separate (in terms of their laser frequency) Doppler-sensitive and Doppler-free two-photon Raman transitions, as well as the two possible k-directions of Doppler-sensitive two-photon Raman transitions, which are ultimately useful in preventing drifts from affecting the sensor's output measurements. In some embodiments, the angle of an interrogation laser beam of the Raman interrogation laser beams to the one or more atomic beams is selected to break degeneracy using a Doppler shift by tilting by an angle [symbol] ϕ. In various embodiments, the angle [symbol] ϕ comprises one of the following: 90 degrees plus 10, 5, 2.5, 2.0, 1.5, 1.0, 0.5, or minus 0.5, 1.0, 1.5, 2.0, 2.5, 5, or 10 degrees, an angle between 80 and 100 degrees, between 90 degrees plus 10, 5, 2.5, 2.0, 1.5, 1.0, or 0.5 and 90 degrees minus 0.5, 1.0, 1.5, 2.0, 2.5, 5, or 10 degrees, or any other appropriate angle. In some embodiments, the Raman interrogation laser beams are in the plane of the two atomic beams.

Atomic source 102 generates atomic beam 104. Atomic source 106 generates atomic beam 108. In some embodiments, atomic source 102 and atomic source 106 are each thermal beams from an effusive oven. Atomic source 102 and atomic source 106 can be produced by heating a source of appropriate atoms to form a vapor. Any atoms with transitions amenable to atomic physics techniques using available lasers may be used; for example, alkali atoms such as cesium, rubidium, etc. The vapor is collimated by a nozzle or array of collimating holes to form an atomic beam such as atomic beam 104 and/or atomic beam 108. In some embodiments, the one or more atomic beams comprise two atomic beams where the two atomic beams cross at an angle less than or equal to five degrees.

State preparation beam 110 and state preparation beam 112 put atoms from atomic beam 104 and atomic beam 108 into a desired internal quantum state by creating state-prepared atomic beams. For example, in the case of cesium, state preparation beam 110 and state preparation beam 112 simultaneously clear the F=4 ground state and optically pump the F=3 ground state atoms into the m_{F}=0 magnetic sublevel. State preparation beam 110 and state preparation beam 112 may have an angle [symbol] λ ( [symbol] λ) relative to atomic beam 104 and atomic beam 108 in order to ensure all atoms with a particular velocity are cleared out of the F=4 ground state used for fluorescence detection. In some embodiments, state preparation beam 110 state preparation beam 112 are orthogonal (e.g., angle λ comprises 90°) to atomic beam 104 and atomic beam 108, respectively, in order to ensure that atoms irrespective of their velocities are cleared out of the F=4 ground state used for fluorescence detection.

The state-prepared atomic beams then enter the atom interferometer (i.e., one state prepared atomic beam (atomic beam 104) enters from the left and one (atomic beam 108) enters from the right), which is created using a sequence of three interferometer interrogation beams (i.e., Raman beam A 118, Raman beam B 120, and Raman beam C 122) that are at an angle [symbol] ϕ with respect to atomic beam 104 and atomic beam 108. In some embodiments, the Raman interrogation laser beams cross each of the two atomic beams at symmetric angles.

For a given Doppler-sensitive Raman transition, the Raman beams will only be resonant with atoms with a given velocity projection vₜ along the Raman beams. This resonance corresponds to a combination of a given atom's forward velocity vₗ along its trajectory and the tilt angle φ of the Raman beams with respect to that atom's trajectory: vₜ=vₗ cos φ. Due to this relationship, for a given Raman beam configuration corresponding to a fixed vₜ, changes in oven temperature or pointing will have a first-order effect on the mean vₗ of atoms participating in the interferometer (i.e., resonant with the Raman transitions), and thus a first-order effect on interferometer scale factor and significant sources of bias, such as the clearing phase.

Raman beam A 118, Raman beam B 120, and Raman beam C 122 comprise the interferometer interrogation beams. For example, interferometer interrogation beams are two-photon stimulated Raman transitions that are tuned to coherently split into a superposition of states and then recombine the atomic wave packets. At the output of the interferometer one can monitor the atomic population in the states that partake in the interferometer—in the case of cesium, in either the F=3 or F=4 atomic states, by using detection beam 114 and detection beam 116 which can be tuned, in the case of cesium, to the F=4 resonance to induce fluorescence proportional to the number of atoms in the F=4 state. The number of atoms in a particular atomic state after atoms exit the interferometer depends on the rotation or acceleration of the optical platform relative to the inertial trajectory of atoms in vacuum. In some embodiments, the number of atoms in a particular state can be measured by a photodetector that detects fluorescence scattered by atoms resonant with one or more detection laser beams.

Detection beam 114 and detection beam 116 are used to detect fluorescence scattered by atoms resonant with one or more detection laser beams. In some embodiments, detection beam 114 and detection beam 116 are used to detect absorption of atoms resonant with one or more detection laser beams. In some embodiments, an angle θ ( [symbol] θ) is introduced between the detection beam 114 and atomic beam 104 as well as between detection beam 116 and atomic beam 108 to provide velocity selectivity in the detected atom signal via the Doppler shift associated with the detection beam wave-vector and the atomic velocity. This reduces the spread in atomic velocities which are effectively detected such that contrast is maintained across larger accelerations. For example, the Doppler effect is used by angling the detection beam 114 with respect to the atomic beam 104 after the interferometer sequence Raman beam 118, Raman beam 120, and Raman beam 122 in order to decrease the longitudinal velocity width of atoms contributing to the signal. The detection beams will only be resonant with atoms with a given velocity projection v_{d} along the detection beam. This resonance corresponds to a combination of a given atom's forward velocity vₗ along its trajectory and the tilt angle θ of the detection beams with respect to that atom's trajectory v_{d} vₗ cos θ. The addition of a tilted detection beam can greatly reduce signal drifts by narrowing the range of velocities that are within the resonance condition. In some embodiments, a pulse time width or a pulse beam width interacting with the one or more atomic beams are selected to determine the second velocity selectivity.

The combination of angled Raman beam and angled detection beam serves to effectively narrow the region in the velocity-angle phase space for atoms that both participate in the interferometer (are resonant with Raman beams) and are detected at the end (are resonant with the detection beam). As a result, the sensitivity of scale factor and bias drifts that would otherwise be first-order to changes in the mean velocity or angle becomes second-order, which, can lead to significant sensor performance improvements.

Modulating one or more of Raman beam A 118, Raman beam B 120, and Raman beam C 122 can lead to significant mitigation in the effects of contrast and changing atom number.

In some embodiments, one or more modulations is applied by toggling a phase, shifting the phase, toggling a frequency, shifting the frequency, shifting the phase and shifting the frequency, shifting the frequency and toggling the phase, toggling the phase and shifting the frequency, or toggling the phase and toggling the frequency of one or more of the interrogatory beams.

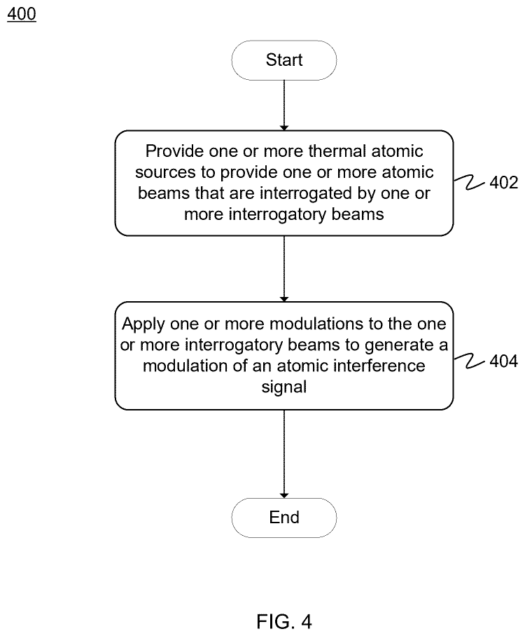

In various embodiments, a sinusoidal wave modulation is applied to one or more of the Raman Beams. Various embodiments that apply a sinusoidal wave to one or more of the Raman Beams are described below in FIGS. 4, 5, and 6.

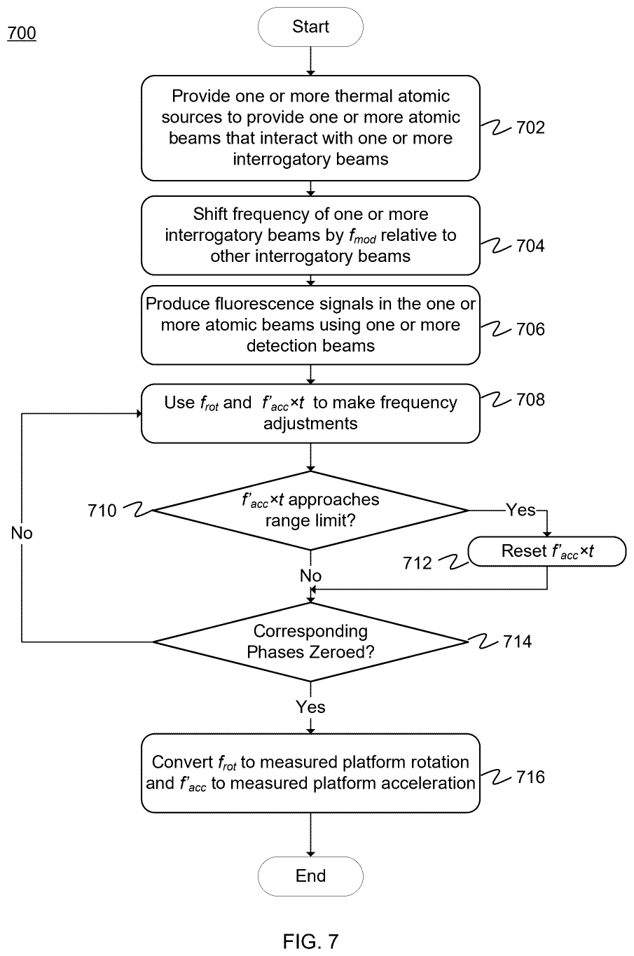

In various embodiments, a square-wave modulation is applied to one or more of the Raman Beams. Various embodiments that apply a square-wave to one or more of the Raman Beams are described below in FIGS. 7, 8, 9, and 10.

In some embodiments, modulation is applied on one or more interrogation beams. For example, a modulation is applied to a center laser beam or a second laser beam (e.g., Raman Beam B 120) or modulation is applied to a first laser beam of the interrogation laser beams (e.g., Raman Beam A 118 or Raman Beam C 122 for Atomic Beam A 104 or Atomic Beam B 108, respectively), a third laser beam of the interrogation laser beams (e.g., Raman Beam A 118 or Raman Beam C 122 for Atomic Beam B 108 or Atomic Beam A 104, respectively), or a first laser beam of the interrogation laser beams and a third laser beam of the interrogation laser beams (e.g., Raman Beam A 118 and Raman Beam C 122).

In some embodiments, an interferometer phase is used to generate an error signal for a servo. In some embodiments, a servo operates simultaneously on a first atomic interference signal detected from a first atomic beam and a second atomic interference signal detected from a second atomic beam.

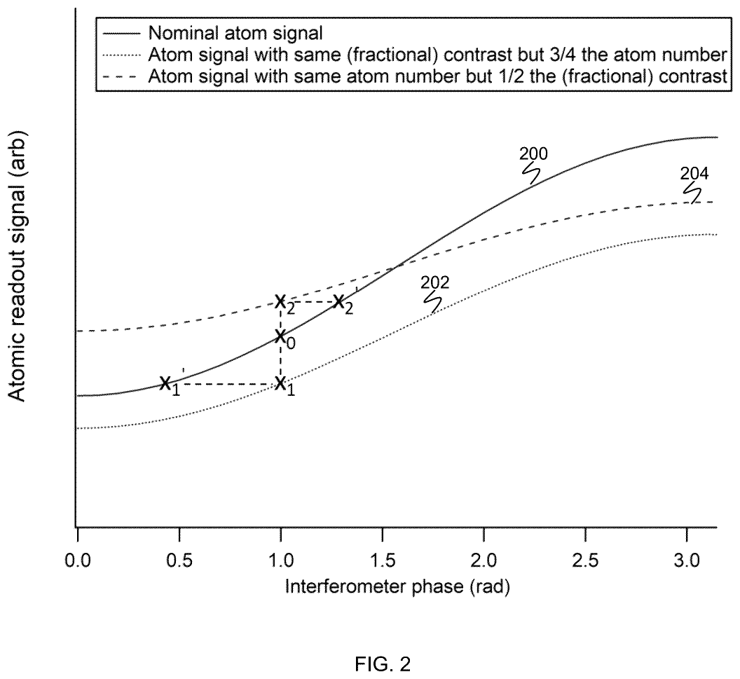

FIG. 2 is a graph demonstrating how fluctuations in interferometer contrast and/or atom number produce errors in interferometer phase readout for single-point measurements that do not account for these fluctuations in accordance with some embodiments. In some embodiments, the graph of FIG. 2 represents a representation of interferometer output derived from a signal detected from measuring detection beam 114 of FIG. 1 or a signal detected from measuring detection beam 116 of FIG. 1. In the example shown, nominal signal from a detector is shown as solid line curve 200, which is sinusoidal with increasing interferometer phase.

In the example shown, an interferometer phase of 1 rad corresponds to an atomic readout signal given by x₀ for nominal interferometer atom number and (fractional) contrast. A reduction in atom number, indicated by the dotted line, would instead cause interferometer phase of ˜1 rad to produce atomic readout signal corresponding to x₁, which would naively be interpreted as corresponding to x₁′ for nominal atom number and contrast, which gives interferometer phase of ˜0.5 rad. A reduction in contrast, indicated by the dashed line, would cause interferometer phase of 1 rad to produce atomic readout signal corresponding to x₂, which would naively be interpreted as corresponding to x₂′ for nominal atom number and contrast, which gives interferometer phase of ˜1.3 rad. Continuously scanning over the entire phase vs signal curve enables correctly extracting phase despite changes in interferometer contrast and/or atom number. For example, in tracing over curve 200 scanning over the x-axis with center point x₀ enables correctly determining interferometer phase of x₀ (e.g., 1.0 rad phase). Similarly, in tracing over curve 202 scanning over the x-axis with center point x₁ enables correctly determining interferometer phase of x₁ (e.g., 1.0 rad phase). And also, in tracing over curve 204 scanning over the x-axis with center point x₂ enables correctly determining interferometer phase of x₂ (e.g., 1.0 rad phase).

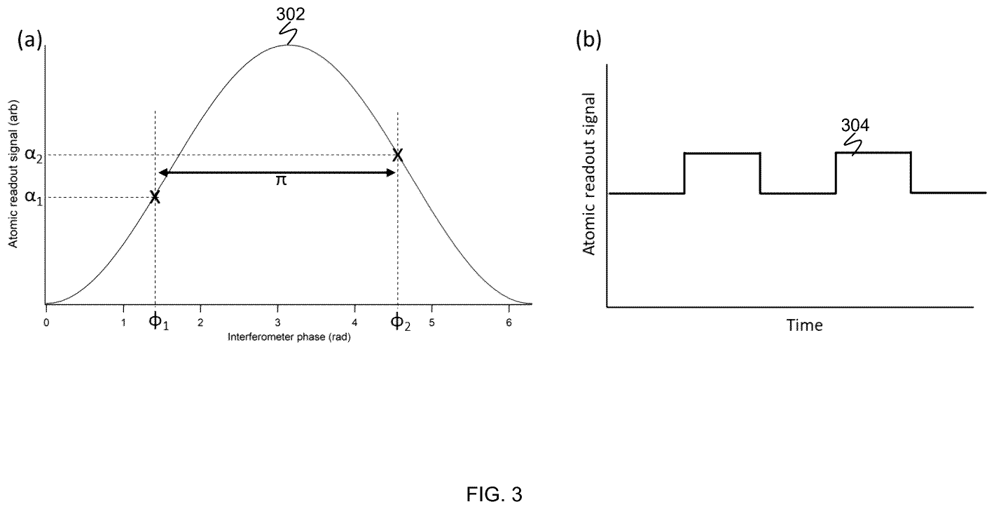

FIG. 3 is a graph demonstrating the toggling of an interferometer phase and its effects on the readout in accordance with some embodiments. In some embodiments, the interferometer phase of line 302 is similar to solid line curve 200. In the example shown, line 302 is the interferometer phase. The interferometer phase is toggled between ϕ₁ and ϕ₂ which are separated by π. This causes the readout to jump between α₁ and α₂ in time. Line 304 is the corresponding readout signal that jumps between α₁ and α₂ in time as depicted.

FIG. 4 is a flow diagram illustrating an embodiment of modulation detection. In some embodiments, one or more modulations are applied to one or more of the interrogation beams of an interferometer device, such that a modulation in the atom interferometer signal is generated. In some embodiments, the process of FIG. 4 is implemented on the system of FIG. 1.

At 402, one or more thermal atomic sources provide one or more atomic beams that interact with one or more interrogatory beams. For example, atomic beams A and B generated from atomic sources A and B interact with Raman Beams A, B, and C as the atoms transit through those beams.

At 403, one or more modulations is applied the one or more interrogatory beams such that a modulation of the atom interference signal is generated. The one or more modulations applied to the one or more interrogatory beams may comprise of sinusoidal waves. The one or more modulations applied to the one or more interrogatory beams may comprise of square-waves.

The interferometer device may be configured to execute various forms of operations including, open-loop sinusoidal modulation, closed-loop sinusoidal modulation, closed-loop chirped sinusoidal-wave modulation, open-loop square-wave modulation, simultaneous closed-loop square-wave modulation, or interleaved closed-loop square-wave modulation.

In some embodiments, the amplitude of the atomic interference signal is used to tune power levels of the set of atom interference lasers to maximize an amplitude of the atomic interference signal.

In some embodiments, one or more modulations is applied by toggling a phase, shifting the phase, toggling a frequency, shifting the frequency, shifting the phase and shifting the frequency, shifting the frequency and toggling the phase, toggling the phase and shifting the frequency, or toggling the phase and toggling the frequency of one or more of the interrogatory beams.

### Sinusoidal Modulation

In some embodiments, in

$$a \frac{π}{2} - π - \frac{π}{2}$$

thermal-beam interferometer, the frequency of the π beam may be shifted by a sinusoidal wave of f_{mod} relative to the frequencies of the π/2 beams, generating a continuous scan of the interferometer output phase. Lock-in detection enables extracting the interferometer phase in a way that is independent of interferometer contrast and atom number.

In some embodiments, this measurement is performed simultaneously on two counterpropagating atomic beams. In this case, the interferometer phase for an applied acceleration will have the same sign for the two counterpropagating interferometers. On the other hand, for an applied rotation it will have opposite signs for the two counterpropagating interferometers. In this example, the sum of the interferometer phases for the two counterpropagating interferometers will be proportional to the acceleration rate (in the direction along the Raman laser beams), while the difference of the interferometer phases for the two counterpropagating interferometers will be proportional to the rotation rate (around an axis perpendicular to the plane of the atom beams and Raman laser beams).

In some embodiments, lock-in demodulation can only detect the interferometer phase modulo 2π. Therefore, it is desirable, particularly under high platform dynamics, to operate the device such that the interferometer phases are near zero and the response to inputs is linear. In some embodiments, this is implemented via closed-loop operation, where phases applied to the interferometer laser beams compensate for the inertial phases produced by the platform acceleration and rotation to zero the measured interferometer phase, with the platform acceleration and rotation then extracted from the compensation phases.

In some embodiments, the closed-loop operation of

$$a \frac{π}{2} - π - \frac{π}{2}$$

thermal-beam interferometer can zero out the rotation phase by applying a biasing frequency shift with opposite signs to each of the two π/2 beams where the biasing frequency is proportional to the platform rotation. The platform rotation can then be derived from the biasing frequency shift. Furthermore, as a given atom traverses the interferometer region, both the interferometer phase it accumulates due to applied rotation and the compensation phase applied to it by the rotation-biasing frequency shift will scale linearly with the time it spends in the interferometer. This means that a single rotation-biasing frequency shift will compensate for the rotation phases for atoms of all velocities.

In some embodiments, the acceleration phase is zeroed out by applying a biasing frequency shift with the same sign to the two π/2 beams, where the biasing frequency shift is proportional to platform acceleration. In some embodiments, the acceleration phase is zeroed out by applying a biasing frequency shift to the π beam. The platform acceleration can then be derived from this biasing frequency shift.

When a given atom traverses the interferometer region, the interferometer phase it accumulates due to applied acceleration scales quadratically with the time it spends in the interferometer. However, the compensation phase applied to it by the acceleration-biasing frequency shift will scale linearly with the time it spends in the interferometer. Thus, a single acceleration-biasing frequency shift will fully compensate the acceleration phases for atoms of only one chosen velocity and will only approximately compensate the acceleration phases for atoms of other velocities.

In some embodiments, the acceleration can be fully canceled in closed loop for all atom velocities via chirped acceleration compensation. In chirped acceleration compensation, the applied acceleration is compensated via a linear frequency chirp applied simultaneously to the three Raman beams.

In some embodiments, both the rotational phase and the acceleration phase are zeroed out using a biasing frequency shift. When both phases are zeroed out using a biasing frequency shift, the biasing frequency shift may be of different frequencies.

In some embodiments, the sinusoidal modulation is generated by shifting a second (center) of three of the interrogation laser beams.

In some embodiments, the sinusoidal atom interference signal is demodulated to extract the interferometer phase and/or amplitude. In some embodiments, the extracted interferometer phase may be used as an error signal of a servo. In some embodiments, the servo may operate simultaneously on a first atomic interference signal of a first atomic beam and a second atomic interference signal of a second atomic beam.

In some embodiments, the servo actuates a first frequency and a second frequency, wherein the first frequency is proportional to a sum of the first atomic interference signal of the first atomic beam and the second atomic interference signal of the second atomic beam, and wherein the second frequency is proportional to a difference of the first atomic interference signal of the first atomic beam and the second atomic interference signal of the second atomic beam, and the first frequency and the second frequency are added to or subtracted from a frequency of one or more of the interrogation laser beams in order to zero the sum and the difference of a first interferometer phase and a second interferometer phase.

### Open-Loop Sinusoidal

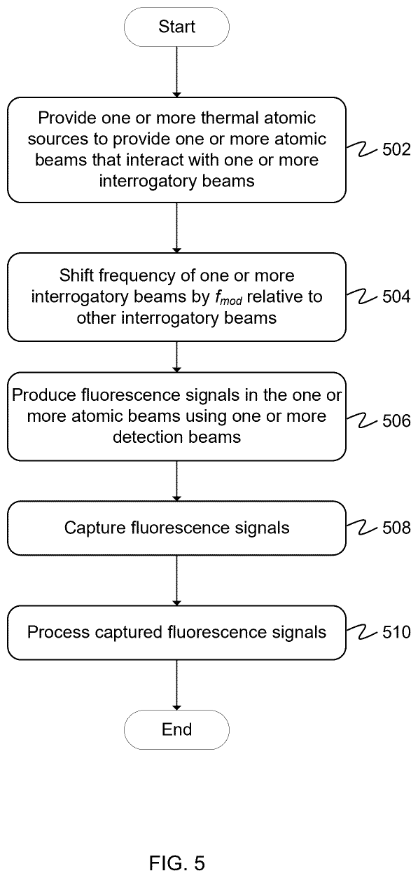

FIG. 5 is a flow diagram illustrating an embodiment of modulation detection using open-loop sinusoidal wave modulation. In some embodiments, the process of FIG. 5 is implemented on the system of FIG. 1. In some embodiments, sinusoidal modulation is generated by applying a frequency offset f_{mod} to Raman Beam B. This leads the phase detected at the output of both Interferometers A and B (corresponding to Atomic beams A and B, respectively) to be modulated at 2f_{mod}. The phase of the modulated signal, when referenced to the phase of the initial modulation (frequency-doubled) via lock-in demodulation, is proportional to the interferometer phase. The amplitudes of the modulated signal will be proportional to the interferometer contrast.

In open-loop, the sum of the interferometer phases for the two counterpropagating interferometers will be proportional to the platform acceleration in a direction along the Raman beams, while the difference of the interferometer phases for the two accelerometers will be proportional to the platform rotation around an axis perpendicular to the plane of the Raman beams.

At 502, one or more thermal atomic sources provide one or more atomic beams that interact with one or more interrogatory beams. For example, atomic beams A and B generated from atomic sources A and B interact with Raman Beams A, B, and C as the atoms transit through those beams.

At 504, the frequency of one or more interrogatory beams is shifted by f_{mod} relative to other interrogatory beams. For example, the frequency of Raman Beam B is shifted by f_{mod} compared to the frequencies of Raman Beam A and Raman Beam C.

At 506, fluorescence signals are produced in the one or more atomic beams using one or more detection beams. In some embodiments, detection beams produce fluorescence signals in two atomic beams that are sinusoidal signals at 2f_{mod}. The phases of the fluorescence signals in the two atomic beams are proportional to the interferometer phase and the amplitudes of the modulated signals proportional to the interferometer contrast. The interferometer phase and amplitudes can be determined by referencing the phase of the original modulation frequency, after frequency-doubling it, via lock-in demodulation.

At 508, the fluorescence signals are captured. In some embodiments, the fluorescence signals are captured on photodiodes.

At 510, the fluorescence signals are processed. The fluorescence signals are processed to extract the amplitudes and phases for the one or more readout signals. In some embodiments, processing comprises demodulation. For example, the sum interferometer phases for atomic beams A and B are converted to a measured platform acceleration. Furthermore, the difference between the interferometer phases for atomic beams A and B are converted to a measured platform rotation.

### Closed Loop Sinusoidal

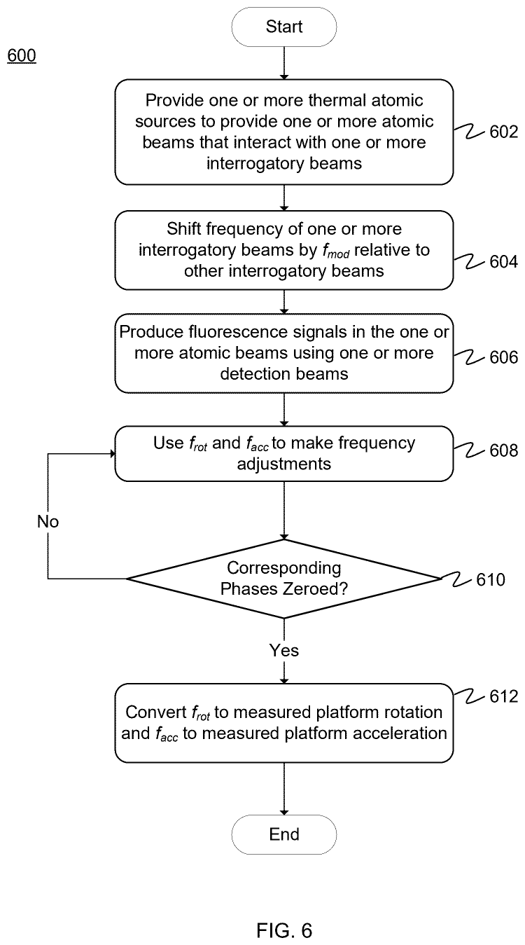

FIG. 6 is a flow diagram illustrating an embodiment of modulation detection using closed-loop sinusoidal wave modulation. In some embodiments, the process of FIG. 6 is implemented on the system of FIG. 1. In some embodiments, a frequency offset fᵣₒₜ and f_{acc} are applied to one or more interrogatory beams. For example, a frequency offset fᵣₒₜ is applied to Raman Beams A and C to zero the difference of the two interferometer phases. A different frequency offset f_{acc} is applied to both Raman Beams A and C with the same sign.

In some embodiments, the frequency offset f_{acc} is applied only to Raman Beam B. In this case, fᵣₒₜ will be proportional to the applied rotation and f_{acc} will be proportional to the applied acceleration. When there is a component of gravity along the acceleration sense axis, f_{acc} can be applied to restore interferometer contrast in open loop.

At 602, one or more thermal atomic sources provide one or more atomic beams that interact with one or more interrogatory beams. For example, atomic beams A and B generated from atomic sources A and B interact with Raman Beams A, B, and C as the atoms transit through those beams.

At 604, the frequency of one or more interrogatory beams is shifted by f_{mod} relative to other interrogatory beams. For example, the frequency of Raman Beam B is shifted by f_{mod} compared to the frequencies of Raman Beam A and Raman Beam C.

At 606, fluorescence signals are produced in the one or more atomic beams using one or more detection beams.

At 608, fᵣₒₜ and f_{acc} are used to make frequency adjustments. In some embodiments, during the course of the measurement, fᵣₒₜ and f_{acc} are continuously adjusted to keep the corresponding phases zeroed. In some embodiments, adjustments are made based at least in part on data processing that occurs on the readout signal. For example, A frequency fᵣₒₜ is added to the laser beam frequency of Raman Beam A and subtracted from the laser beam frequency of Raman Beam C in order to zero the rotation phase (the difference of the two interferometer phases), and at the same time a frequency f_{acc} is added to the laser beam frequency of Raman Beam B in order to zero the acceleration phase (the sum of the two interferometer phases).

At 610, whether the corresponding phases are zeroed is determined. Data processing on the output signals is continuously executed to determine a fᵣₒₜ and f_{acc} such that the corresponding phases are zeroed. In response to a determination that the current fᵣₒₜ and f_{acc} do not result in the corresponding phases being zeroed, control passes to 608 and adjusts fᵣₒₜ and f_{acc} to match the determined fᵣₒₜ and f_{acc}. In response to a determination that the corresponding phases are zeroed, control passes to 612.

At 612, fᵣₒₜ is converted to a measured platform rotation while f_{acc} is converted to a measured platform acceleration, and the process ends.

In some embodiments, a servo actuates a first frequency (e.g., fᵣₒₜ), a second frequency (e.g., f_{acc}), or the first frequency and the second frequency, wherein the first frequency is proportional to a sum of the first atomic interference signal of the first atomic beam and the second atomic interference signal of the second atomic beam, and wherein the second frequency is proportional to a difference of the first atomic interference signal of the first atomic beam and the second atomic interference signal of the second atomic beam, and the first frequency and the second frequency are added to or subtracted from a frequency of one or more of the interrogation laser beams in order to zero the sum, the difference, or the sum and the difference of a first interferometer phase and a second interferometer phase.

### Chirped Closed Loop Sinusoidal

FIG. 7 is a flow diagram illustrating an embodiment of modulation detection using closed-loop chirped sinusoidal-wave modulation. In some embodiments, the process of FIG. 7 is implemented on the system of FIG. 1. In “chirped” closed-loop simultaneous operation, zeroing the sum of the two interferometer phases is done via an applied linear frequency chirp one or more interrogatory beams. For example, the applied linear frequency chirp may be applied to the three interrogatory beams (Raman A, Raman B, and Raman C). Applying the chirp does a better job of maintaining interferometer contrast under dynamics. This is because it optimally compensates for dephasing between atoms with different velocities. The synthesizer that generates the linear frequency chirp will have a finite range. Thus, depending on the dynamics, it may need to be reset periodically. The resulting dead time may be tuned/optimized for a given application.

At 702, one or more thermal atomic sources provide one or more atomic beams that interact with one or more interrogatory beams. For example, atomic beams A and B generated from atomic sources A and B interact with Raman Beams A, B, and C as the atoms transit through those beams.

At 704, the frequency of one or more interrogatory beams is shifted by f_{mod} relative to other interrogatory beams. For example, the frequency of Raman Beam B is shifted by f_{mod} compared to the frequencies of Raman Beam A and Raman Beam C.

At 706, fluorescence signals are produced in the one or more atomic beams using one or more detection beams.

At 708, fᵣₒₜ and f′_{acc}×t are used to make frequency adjustments. In some embodiments, during the course of the measurement, fᵣₒₜ and f′_{acc}×t are continuously adjusted to keep the corresponding phases zeroed. In some embodiments, adjustments are made based at least in part on data processing that occurs on the readout signal. For example, a frequency fᵣₒₜ is added to the laser beam frequency of Raman Beam A and subtracted from the laser beam frequency of Raman Beam C in order to zero the rotation phase (the difference of the two interferometer phases), and at the same time a linear frequency chirp f′_{acc}×t is added to the laser beam frequencies of both Raman Beam A and Raman Beam C in order to zero the acceleration phase (the sum of the two interferometer phases)

At 710, it is determined whether f′_{acc}×t is approaching a range limit. In response to a determination that f′_{acc}×t is approaching a range limit, control passes to 712. In response to a determination, that the f′_{acc}×t is not approaching a range limit, control passes to 714.

At 712, f′_{acc}×t is reset, and control passes to 714. When the frequency chirp f′_{acc}×t approaches the range limit of the frequency synthesizer, it may need to be periodically reset back to zero.

At 714, whether the corresponding phases are zeroed is determined. Data processing on the output signals is continuously executed to determine a fᵣₒₜ and f′_{acc}×t such that the corresponding phases are zeroed. In response to a determination that the current fᵣₒₜ and f′_{acc}×t do not result in the corresponding phases being zeroed, control passes to 708. In response to a determination that the corresponding phases are zeroed, control passes to 716.

At 716, fᵣₒₜ is converted to a measured platform rotation while f′_{acc} is converted to a measured platform acceleration. In some embodiments, step 716 comprises demodulation.

Within the above description, there are examples employing 2 atom beams and 3 interference laser beams. However, similar sinusoidal wave modulation schemes can be implemented in sensor architectures with larger numbers of atom beams and/or larger numbers of interference laser beams.

In some embodiments, the servo actuates one frequency and one linear frequency chirp, wherein the one frequency is proportional to a difference of the first atomic interference signal of the first atomic beam and the second atomic interference signal of the second atomic beam, and wherein the one linear frequency chirp is proportional to a sum of the first atomic interference signal of the first atomic beam and the second atomic interference signal of the second atomic beam, and the one frequency and one linear frequency chirp are added to or subtracted from a frequency of one or more of the interference beams in order to zero the sum and the difference of a first interferometer phase and a second interferometer phase.

In some embodiments, the amplitude of the atomic interference signal is used to tune power levels of the set of atom interference lasers to maximize an amplitude of the atomic interference signal.

### Square-Wave Modulation

In some embodiments, lock-in demodulation with the use of one or more biasing frequencies may be vulnerable to the fluctuations in the phase of the reference signal. This may lead to fluctuations in the readout phase. Furthermore, the bandwidth of lock-in demodulation is limited by the need to use a low-pass filter to filter out higher harmonics of 2f_{mod}.

In some embodiments, square waves are applied for modulation of the interferometer phase. This provides some desirable advantages over the use of sinusoidal waves. One advantage is that the sensitivity to RF phase fluctuations is eliminated. A second advantage is that a higher sensor readout bandwidth is enabled. A third advantage is that a higher SNR is achieved.

In some embodiments the square-wave modulation is generated by toggling the phase, the frequency, or the phase and the frequency of a first laser beam of the interrogation laser beams, a third laser beam of the interrogation laser beams, or the first laser beam of the interrogation laser beams and the third laser beam of the interrogation laser beams.

In some embodiments, square-wave modulation is accomplished by modulating the phase of the π pulse laser by π/2 rad, rather than continuously modulating the π pulse laser with a sinusoidal wave frequency. As a result, the phase of the atom signal is toggled by π rad. This is displayed in FIG. 3. When the interferometer phase, which is the average of the two toggle phases, changes, the amplitude of the modulated atomic signal is affected (e.g., the amplitude goes to 0 when the interferometer phase is exactly π rad). The interferometer phase is read out directly via square-wave amplitude, therefore, the effect of RF phase fluctuations is suppressed. Near π rad interferometer phase, where the amplitude of the readout square wave is near 0, the interferometer has maximal sensitivity (i.e. largest change in readout signal for a given small change in interferometer phase), and the amplitude of the square-wave readout signal is linearly proportional to the interferometer phase.

In sinusoidal modulation, the interferometer phase is necessarily scanned over 2π rad, so some time is spent in the least-sensitive phase regions; thus, for optimized square-wave modulation, the SNR is \sqrt{2} times the SNR for sinusoidal modulation.

Because the detected signal from the interferometer varies sinusoidally with the interferometer's phase, it is desirable, particularly under high platform dynamics, to operate the device such that the phase is near zero and the response to inputs is linear. This can be implemented via closed-loop operation.

When the readout is DC-coupled, square-wave modulation can also be used to optimize interferometer signal size by dithering the power of the interferometer laser beams (e.g., Raman A, B, and C) and using the resulting fluctuations in signal size to tune the interferometer laser beams' powers to values that maximize signal size.

In some embodiments, square-wave modulation is generated by toggling the phase of Raman Beam B by π/2 at frequency f_{sq}. This leads to the phase detected at the output of both interferometers A and B (corresponding to atomic beams A and B, respectively) to be toggled by π at f_{sq}, where the amplitude of the detected square wave is, for small interferometer phases, proportional to the interferometer phase. In open loop, the sum of the interferometer phases for the two counterpropagating interferometers will be proportional to the platform acceleration in a direction along the Raman beams, while the difference of the interferometer phases for the two accelerometers will be proportional to the platform rotation around an axis perpendicular to the plane of the Raman beams.

In some embodiments, the phase of the one of the interrogation laser beams is toggled by a multiple of π/2.

In some embodiments, the square-wave modulation is generated by toggling the phase of a second (center) of three of the interrogation laser beams. In some embodiments, the square-wave modulation is generated by toggling the phase of a first or third of three of the interrogation laser beams. The square-wave modulation may be used as an error signal of a servo.

In some embodiments, the servo operates in interleaved fashion on interference signals of two or more atomic beams of the one or more atomic beams. In some embodiments, the servo actuates a frequency proportional to the error signal that is added to and/or subtracted from one or more of the interrogation laser beams. In some embodiments, the servo operates simultaneously on a first atomic interference signal of a first atomic beam and a second atomic interference signal of a second atomic beam

In some embodiments, the servo actuates a first frequency and a second frequency, wherein the first frequency is proportional to a sum of the first atomic interference signal of the first atomic beam and the second atomic interference signal of the second atomic beam, and wherein a second frequency is proportional to a difference of the first atomic interference signal of the first atomic beam and the second atomic interference signal of the second atomic beam, and the first frequency and the second frequency are added to or subtracted from a frequency of one or more of the interference beams in order to zero an amplitude of the square-wave modulation signals.

In some embodiments, an average size of the atomic interference signal over a square-wave modulation cycle is used to tune power levels of the set of atom interference lasers to maximize a size of the atomic interference signal.

In some embodiments, one or more thermal atomic sources provides one or more atomic beams. A set of atom interference lasers are disposed to provide interrogation laser beams that interrogate the one or more atomic beams to assist in generating atom interference. In some embodiments, the phase of one of the interrogation laser beams is toggled to generate a square-wave modulation of the atomic interference signal.

### Open-Loop Square-Wave Modulation

In some embodiments, the sensor is configured to execute an open-loop operation with square-wave modulation. When an open-loop interferometer phase measurement is performed simultaneously on two counterpropagating atomic beams, the square-wave readout signal for an applied acceleration will be in-phase for the two counterpropagating interferometers. However, for an applied rotation it will be out-of-phase for the two counterpropagating interferometers. Thus, the average of the interferometer phases for the two counterpropagating interferometers will be proportional to the acceleration rate (in the direction along the Raman laser beams), while the difference of the interferometer phases for the two counterpropagating interferometers will be proportional to the rotation rate (around an axis perpendicular to the plane of the atom beams and Raman laser beams).

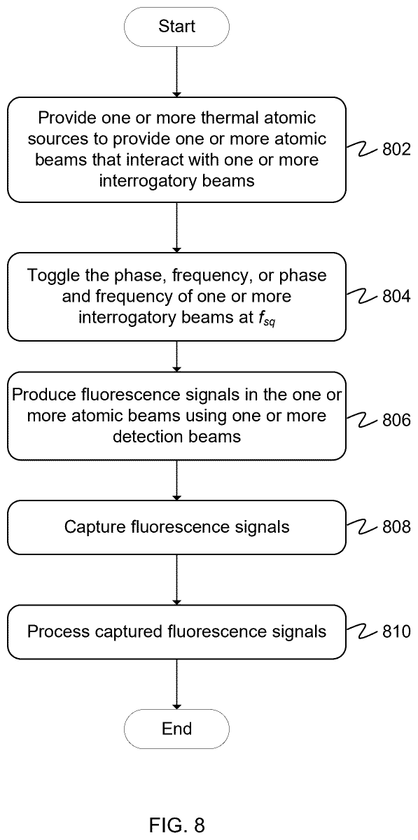

FIG. 8 is a flow diagram illustrating an embodiment of modulation detection using open-loop square-wave modulation. In some embodiments, the process of FIG. 8 is implemented on the system of FIG. 1.

In the example shown, at 802, one or more thermal atomic sources provide one or more atomic beams that interact with one or more interrogatory beams. For example, atomic beams A and B generated from atomic sources A and B interact with Raman Beams A, B, and C as the atoms transit through those beams.

At 804, the phase, the frequency, or the phase and the frequency of one or more interrogatory beams are toggled at one or more interrogatory beams are toggled at f_{sq}. For example, the phase, the frequency, or the phase and the frequency of Raman Beam B may be toggled by π/2 at a frequency of f_{sq}.

At 806, fluorescence signals are produced in the one or more atomic beams using one or more detection beams. In some embodiments, detection beams produce fluorescence signals in two atomic beams that are square waves at f_{sq}. In some embodiments, the amplitude of the square waves is proportional of the phases of the two interferometers.

At 808, the fluorescence signals are captured. In some embodiments, the fluorescence signals are captured on photodiodes

At 810, the fluorescence signals are processed. In some embodiments, fluorescence signals are processed to extract the amplitudes for the readout signals and convert those amplitudes into interferometer phases, which are then converted into acceleration and rotation measurements. For example, the sum interferometer phases for atomic beams A and B are converted to a measured platform acceleration. Furthermore, the difference between the interferometer phases for atomic beams A and B are converted to a measured platform rotation.

### Simultaneous Closed-Loop Square Wave

In some embodiments, a closed-loop operation is used. In a closed-loop operation, the phases applied to the interferometer laser beams compensate for the inertial phases produced by the platform acceleration and rotation to zero the measured interferometer phase, with the platform acceleration and rotation then extracted from the compensation phases. In embodiments where a closed-loop operation is used, a high-bandwidth phase servo may be used to capture the full bandwidth of platform dynamics, and the higher sensor readout bandwidth enabled by square-wave modulation enables higher closed-loop phase servo bandwidth.

In some embodiments, the sensor can be operated in simultaneous closed-loop mode. In a simultaneous closed-loop mode, rather than zeroing the phase of each interferometer at different times, they are servo'ed simultaneously by applying two types of feedback. One type of feedback zeroes the rotation phase (the difference of the two interferometer phases) and another type of feedback zeroes the acceleration phase (the sum of the two interferometer phases).

In some embodiments, the square-wave modulation is generated by toggling a second (center) of three of the interrogation laser beams.

In some embodiments, the square-wave modulation is generated by toggling the first or third of three of the interrogation laser beams.

For example, in “standard” closed-loop simultaneous operation, a frequency offset fᵣₒₜ is applied to Raman Beams A and C to zero the difference of the two interferometer phases and a different frequency offset f_{acc} is applied with the same sign to zero the sum of the two interferometer phases. In this example, fᵣₒₜ will be proportional to the applied rotation and f_{acc} will be proportional to the applied acceleration.

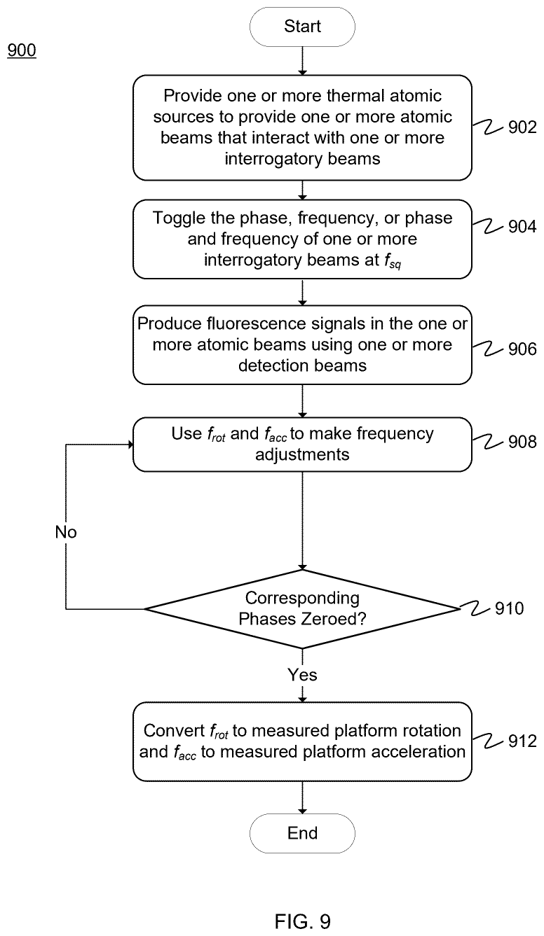

FIG. 9 is a flow diagram illustrating an embodiment of modulation detection using simultaneous closed-loop square-wave modulation. In some embodiments, the process of FIG. 9 is implemented on the system of FIG. 1.

In the example shown, at 902, one or more thermal atomic sources provide one or more atomic beams that interact with one or more interrogatory beams. For example, atomic beams A and B generated from atomic sources A and B interact with Raman Beams A, B, and C as the atoms transit through those beams.

At 904, the phase, the frequency, or the phase and the frequency of one or more interrogatory beams are toggled at at f_{sq}. For example, the phase, the frequency, or the phase and the frequency of Raman Beam B may be toggled by π/2 at a frequency of f_{sq}.

At 906, fluorescence signals are produced in the one or more atomic beams using one or more detection beams.

At 908, fᵣₒₜ and f_{acc} are used to make frequency adjustments. In some embodiments, adjustments are made based at least in part on data processing that occurs on the readout signal. For example, fᵣₒₜ and f_{acc} may be adjusted by changing the frequency. In some embodiments, the frequency fᵣₒₜ is added to an interrogatory beam and is subtracted from another interrogatory beam, simultaneously frequency f_{acc} to added to one or more interrogatory beams. For example, frequency fᵣₒₜ is added to the laser beam frequency of Raman Beam A and subtracted from the laser beam frequency of Raman Beam C and at the same time the frequency f_{acc} is added to the laser beam frequencies of both Raman Beam A and Raman Beam C in order to zero the amplitudes of both the square-wave fluorescence signals.

At 910, whether the corresponding phases are zeroed is determined. Data processing on the output signals is continuously executed to determine a fᵣₒₜ and f_{acc} such that the corresponding phases are zeroed. In response to a determination that the current fᵣₒₜ and f_{acc} do not result in the corresponding phases being zeroed, and control passes to 908 and adjusts fᵣₒₜ and f_{acc} to match the determined fᵣₒₜ and f_{acc}. In response to a determination that the corresponding phases are zeroed, and control passes to 912.

At 912, fᵣₒₜ is converted to a measured platform rotation while f_{acc} is converted to a measured platform acceleration.

### Interleaved Closed-Loop Square Wave

In some embodiments, the sensor can be operated in interleaved closed-loop mode, where the phases for the two counterpropagating atom beams are zeroed during alternating square-wave cycles. This can enable optimal zeroing of both acceleration and rotation. The servo compensation phases from adjacent cycles corresponding to zeroing of the phases for the two counterpropagating beams can then be added or subtracted to extract the rotation and acceleration signals, respectively. In this case, the phase servos work best for rotations and accelerations that are changing slowly compared to the square-wave modulation frequency, and thus the high modulation frequency enabled by square wave modulation enables high sensor measurement bandwidth.

For example, in closed-loop interleaved operation, a frequency offset f_{cl} is applied to Raman Beams A and C with opposite sign (+f_{cl} to Raman Beam A and −f_{cl} to Raman Beam C) to zero the interferometer phase. For applied rotations, the same fi will zero the phases of both interferometers, while, for applied accelerations, if f_{cl} zeroes the phase of one interferometer, −f_{cl} will zero the phase of the other interferometer. To extract the acceleration and rotation, the sensor is operated in interleaved mode, so that the phases of the two interferometers are zeroed in alternating cycles of square wave modulation, using f_{clA} to zero the phase of Interferometer A and f_{clC} to zero the phase of Interferometer C. In that case, the sum of f_{clA} and f_{clC} will be proportional to the applied rotation and the difference of f_{clA} and f_{clC} will be proportional to the applied acceleration.

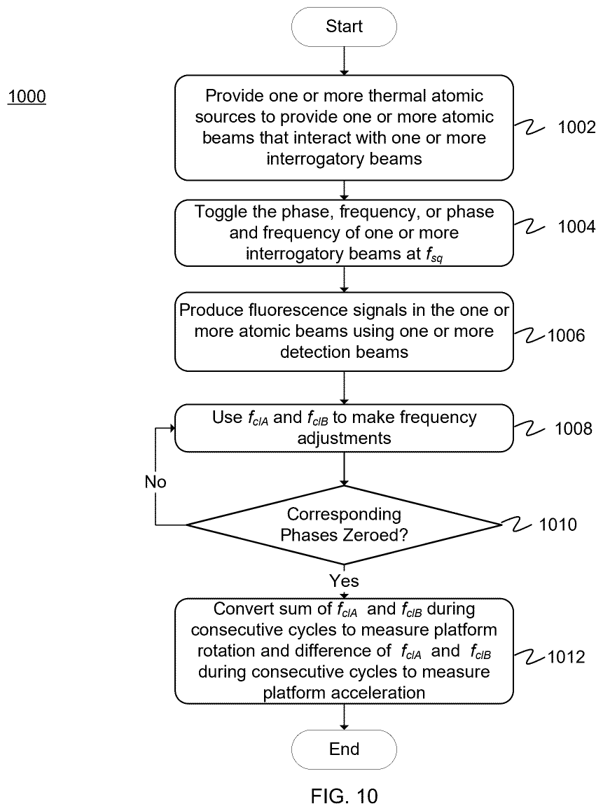

FIG. 10 is a flow diagram illustrating an embodiment of modulation detection using interleaved closed-loop square-wave modulation. In some embodiments, the process of FIG. 10 is implemented on the system of FIG. 1.

In the example shown, at 1002, one or more thermal atomic sources provide one or more atomic beams that interact with one or more interrogatory beams. For example, atomic beams A and B generated from atomic sources A and B interact with Raman Beams A, B, and C as the atoms transit through those beams.

At 1004, the phase, frequency, or the phase and the frequency of one or more interrogatory beams are toggled at f_{sq}. For example, the phase, the frequency, or the phase and the frequency of Raman Beam B may be toggled by π/2 at a frequency of f_{sq}.

At 1006, fluorescence signals are produced in the one or more atomic beams using one or more detection beams.

At 1008, f_{clA} and f_{clB} are used to make frequency adjustments. In some embodiments, adjustments are made based at least in part on data processing that occurs on the readout signal. For example, f_{clA} and f_{clB} may be adjusted by changing the frequency. In some embodiments, a frequency f_{clA} is added to a first interrogation beam and subtracted from a third interrogation beam. For example, where every odd cycle is an alternate period, on an odd square-wave modulation cycle, a frequency f_{clA} is added to the laser beam frequency of Raman Beam A and subtracted from the laser beam frequency of Raman Beam C in order to zero the amplitude of the square wave fluorescence signal corresponding to atomic beam A during the alternate (e.g. odd) cycle. In some embodiments, where every even cycle is an alternate period, on an even square-wave modulation cycle, a frequency f_{clB} may be added to the laser beam frequency of Raman Beam A and subtracted from the laser beam frequency of Raman Beam C in order to zero the amplitude of the square wave fluorescence signal corresponding to atomic beam B during the non-alternate (e.g. even) cycle.

At 1010, whether the corresponding phases are zeroed is determined. Data processing on the output signals is continuously executed to determine a f_{clA} and f_{clB} such that the corresponding phases are zeroed. In response to a determination that the current f_{clA} and f_{clB} do not result in the corresponding phases being zeroed, control passes to 1008 and adjusts f_{clA} and f_{clB}. In response to a determination that the corresponding phases are zeroed, control passes to 1012.

At 1012, the sum of f_{clA} and f_{clB} during consecutive cycles are converted to measure platform rotation and the difference of f_{clA} and f_{clB} during consecutive cycles are converted to measure platform acceleration, and the process ends.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A device, comprising:
one or more thermal atomic sources to provide one or more atomic beams;
a set of atom interference lasers disposed to provide interrogation laser beams that interrogate the one or more atomic beams to assist in generating atom interference, wherein a phase, a frequency, or a phase and a frequency of one interrogation laser beams of the interrogation laser beams is toggled, shifted, or toggled and shifted to generate a modulation of an atomic interference signal.

2. The device as in claim 1, wherein the modulation comprises a sinusoidal modulation.

3. The device as in claim 2, wherein the sinusoidal modulation is generated by modulating a second laser beam or a center laser beam of the interrogation laser beams.

4. The device as in claim 2, wherein a sinusoidal atom interference signal is demodulated to extract an interferometer phase, an interferometer amplitude, or an interferometer phase and an interferometer amplitude.

5. The device as in claim 4, wherein the interferometer phase is used as an error signal of a servo.

6. The device as in claim 5, wherein the servo operates simultaneously on a first atomic interference signal of a first atomic beam of the one or more atomic beams and a second atomic interference signal of a second atomic beam of the one or more atomic beams.

7. The device as in claim 6, wherein the servo actuates a first frequency and/or a second frequency, or a first frequency and a second frequency, wherein the first frequency is proportional to a sum of the first atomic interference signal of the first atomic beam and the second atomic interference signal of the second atomic beam, and wherein the second frequency is proportional to a difference of the first atomic interference signal of the first atomic beam and the second atomic interference signal of the second atomic beam, and the first frequency and the second frequency are added to or subtracted from a frequency of one or more of the interrogation laser beams in order to zero the sum, the difference, or the sum and the difference of a first interferometer phase and a second interferometer phase.

8. The device as in claim 6, wherein the servo actuates one frequency, one linear frequency chirp, or one frequency and one linear chirp, wherein the one frequency is proportional to a difference of the first atomic interference signal of the first atomic beam and the second atomic interference signal of the second atomic beam, and wherein the one linear frequency chirp is proportional to a sum of the first atomic interference signal of the first atomic beam and the second atomic interference signal of the second atomic beam, and the one frequency and one linear frequency chirp are added to or subtracted from a frequency of one or more of the interference beams in order to zero the sum, the difference, or the sum and the difference of a first interferometer phase and a second interferometer phase.

9. The device as in claim 4, wherein an amplitude of the sinusoidal atomic interference signal is used to tune power levels of the set of atom interference lasers to maximize an amplitude of the atomic interference signal.

10. The device as in claim 1, wherein the modulation comprises a square-wave modulation.

11. The device as in claim 10, wherein a phase of one laser beam of the interrogation laser beams is toggled by a multiple of π/2.

12. The device as in claim 10, wherein the square-wave modulation is generated by toggling the phase, the frequency, or the phase and the frequency of a first laser beam of the interrogation laser beams, a third laser beam of the interrogation laser beams, or a first laser beam of the interrogation laser beams and a third laser beam of the interrogation laser beams.

13. The device as in claim 10, wherein the square-wave modulation is generated by toggling a second laser beam of the interrogation laser beams or a center laser beam of the interrogation laser beams.

14. The device as in claim 10, wherein the square-wave atom interference signal amplitude is converted to an interferometer phase.

15. The device as in claim 14, wherein the interferometer phase is used as an error signal of a servo.

16. The device as in claim 15, wherein the servo operates in interleaved fashion on a first atomic interference signal of a first atomic beam of the one or more atomic beams and a second atomic interference signals of a second atomic beam of the one or more atomic beams.

17. The device as in claim 16, wherein the servo actuates a frequency proportional to an error signal that is added to or subtracted from a frequency of one or more of the interrogation laser beams.

18. The device as in claim 14, wherein the servo operates simultaneously on a first atomic interference signal of a first atomic beam and a second atomic interference signal of a second atomic beam.

19. The device as in claim 18, wherein the servo actuates a first frequency and a second frequency, wherein the first frequency is proportional to a sum of the first atomic interference signal of the first atomic beam and the second atomic interference signal of the second atomic beam, and wherein a second frequency is proportional to a difference of the first atomic interference signal of the first atomic beam and the second atomic interference signal of the second atomic beam, and the first frequency and the second frequency are added to or subtracted from a frequency of one or more of the interference beams in order to zero an amplitude of the square-wave modulation signals.

20. The device as in claim 10, wherein an average size of the atomic interference signal over a square-wave modulation cycle is used to tune power levels of the set of atom interference lasers to maximize a size of the atomic interference signal.

21. A method, comprising:
providing one or more thermal atomic sources to provide one or more atomic beams;
disposing a set of atom interference lasers disposed to provide interrogation laser beams that interrogate the one or more atomic beams to assist in generating atom interference, wherein a phase, a frequency, or the phase and the frequency of one interrogation laser beams of the interrogation laser beams is toggled, shifted, or toggled and shifted to generate a modulation of an atomic interference signal.
